(19) United States
(12) Patent Application Publication
(10) Pub. No.: US 2023/0258227 A1
(43) Pub. Date: Aug. 17, 2023

(54) RADIAL FOIL BEARING FOR SUPPORTING A SHAFT

(71) Applicant: Schaeffler Technologies AG & Co. KG, Herzogenaurach (DE)

(72) Inventors: Bernhard Jakob, Ottensoos (DE); Michael Plogmann, Herzogenaurach (DE); Wolfgang Braun, Garstadt (DE); Hermann Geyer, Vestenbergsgreuth (DE); Christoph Neufeld, Schweinfurt (DE); Viktor Pfarherr, Höchstadt (DE)

(73) Assignee: Schaeffler Technologies AG & Co. KG, Herzogenaurach (DE)

(21) Appl. No.: 18/014,521

(22) PCT Filed: Jun. 9, 2021
(86) PCT No.: PCT/DE2021/100495

§ 371 Date: Jan. 5, 2023

(30) Foreign Application Priority Data
Jul. 7, 2020 (DE) 10 2020 117 888.3

(51) Int. Cl. F16C 17/02

(52) U.S. Cl. CPC F16C 17/024

(57) ABSTRACT

A radial foil bearing for supporting a shaft includes a sleeve-like bearing housing with an inner circumference and at least three foil packs distributed over the inner circumference and covering a portion of the inner circumference. Each of the at least three foil packs has an elastic corrugated foil resting against the inner circumference and a top foil. The elastic corrugated foil includes axially opposite side edges running in a circumferential direction and a narrowed portion disposed on at least one of the axially opposite side edges to reduce an axial width and a radial spring rigidity of the elastic corrugated foil at the narrowed portion. The top foil has an underside resting on the elastic corrugated foil and a top side forming a bearing surface for the shaft.

### CROSS-REFERENCE TO RELATED APPLICATIONS

This application is the U.S. National Phase of PCT Appln. No. PCT/DE2021/100495 filed Jun. 9, 2021, which claims priority to German Application No. DE102020117888.3 filed Jul. 7, 2020, the entire disclosures of which are incorporated by reference herein.

### TECHNICAL FIELD

The present disclosure relates to a radial foil bearing which can be used for the oil-free storage of lightly loaded shafts running at high speeds, for example in turbocompressors for fuel cells in motor vehicles and the like.

### BACKGROUND

Foil bearings are hydrodynamic or aerodynamic bearings in which, in the unloaded state, a bearing surface supporting the rotating shaft is formed by a thin and wear-resistant top foil, which in turn is supported by an elastic corrugated foil arranged between the top foil and a bearing housing. During bearing operation, a hydrodynamic or aerodynamic film forms between the shaft and the top foil, which carries the shaft. Direct movement contact between the shaft and the top foil occurs only during start and stop processes.

A generic radial foil bearing for supporting a shaft is known, for example, from DE 10 2015 224 869 A1. This foil bearing has a sleeve-like bearing housing with three foil packs evenly distributed over the inner circumference of the bearing housing. Each foil pack covers a portion of the inner circumference of the bearing housing, and has an elastic corrugated foil resting against the inner circumference of the bearing housing and a top foil, of which the underside rests on the corrugated foil and the top side forms a bearing surface for the shaft. Insertion grooves extending parallel to the axis of rotation of the bearing and protruding obliquely outwards from the interior into the bearing housing are arranged on the inner circumference. These grooves serve to accommodate the end edges which delimit the top foils and the corrugated foils, each in the circumferential direction, and are tangentially freely movable in the insertion grooves.

In the case of aerodynamic radial foil bearings, however, it has been shown in practice that the aerodynamic film which forms between the shaft and the top foil during bearing operation and which is intended to support the shaft does not have a uniform thickness. It was found that the air pressure caused by the shaft rotation is greatest axially in the center of the bearing cross-section and is sufficient there to compress the elastic corrugated foil in such a way that the required small distance can arise between the top foil and the shaft. On the other hand, the air pressure caused by the shaft rotation drops continuously towards the two side edges of the top foil, which are connected to the ambient air pressure, and is then no longer sufficient directly below the side edges to compress the corrugated foil, which is designed with a uniform radial spring rigidity. The required distance between the top foil and the shaft cannot therefore occur at the side edges of the top foil, so that what is termed edge running can occur at these points, which can lead to undesired contact between the top foil and the shaft, which are the cause of bearing damage and even bearing failure.

### SUMMARY

The present disclosure provides a radial foil bearing in which the undesirable contact between the top foil and the shaft resulting from edge running are effectively avoided and in which the aerodynamic film that forms between the shaft and the top foil during bearing operation has a uniform thickness.

According to the present disclosure, a radial foil bearing includes corrugated foils with at least one narrowed portion locally at their side edges running in the circumferential direction, which reduces their axial width and reduces the radial spring rigidity of the corrugated foils in the region of their side edges.

The present disclosure also provides that narrowed portions are arranged at both side edges of the corrugated foils and both narrowed portions are designed in the shape of circular sections and symmetrically to one another with the same depths and the same lengths of the narrowed portions. Such a design has proved to be particularly suitable for radial foil bearings in which the radial loads are uniform and misalignments of the shaft to be supported are largely ruled out.

An alternative embodiment of the radial foil bearing designed according to the present disclosure provides that the narrowed portions at both side edges of the corrugated foils are also in the form of circular segments but are unsymmetrical to one another with different depths and the same or unequal lengths. An unsymmetrical design of the narrowed portions with the same lengths but different depths has proved to be suitable for radial foil bearings in which misalignments of the shaft to be supported are to be expected or with which warping of the shaft to be supported is to be counteracted.

Another alternative embodiment of the radial foil bearing designed according to the present disclosure provides that the narrowed portions at both side edges of the corrugated foils are unsymmetrical in the circumferential direction and have the same depths and the same lengths. Unsymmetrical in the circumferential direction means that the narrowed portions deviate from the shape of a segment of a circle and instead have a curved or arcuate contour. Such narrowed portions can be advantageous in applications where a specific load direction or load position is to be counteracted.

The present disclosure also provides that the narrowed portions at both side edges of the corrugated foils may extend in the circumferential direction either from the first corrugation crest to the last corrugation crest or only from the second corrugation crest to the penultimate corrugation crest of each corrugated foil. The selection of these lengths of the narrowed portions depends on the desired degree of reduction of axial spring rigidity of the corrugated foils. In the case of radial foil bearings with larger inner diameters of the bearing housing and correspondingly longer corrugated foils and top foils, narrowed portion lengths that are smaller than the ranges mentioned are also possible.

Another example embodiment of the radial foil bearing designed according to the present disclosure provides that the depth of the narrowed portion is dimensioned such that the width of the corrugated foil between the deepest points of both narrowed portions is between 75% and 95% of the axial width of the corrugated foils at their end edges. Within this range it is ensured that the degree of reduction of axial spring rigidity of the corrugated foils in the region of their side edges is neither too high nor too low. However, instead of the narrowed portions, it is also possible to design all the corrugated foils to be axially narrower than the associated top foils, although a special fixation of the corrugated foils in the bearing housing, for example by welding, is necessary in this case.

The radial foil bearing designed according to the present disclosure has corrugated foils with a reduced radial spring rigidity in the region of their side edges due to the design of these corrugated foils with local narrowed portions at their side edges reducing their axial width, so that the air pressure caused by the shaft rotation is also sufficient at the two side edges of the top film connected to the ambient air pressure to compress the corrugated foil in such a way that the required small distance can arise between the top foil and the shaft. As a result, the described edge running, which was previously the cause of bearing damage or bearing failures, can no longer occur at these points.

### BRIEF DESCRIPTION OF THE DRAWINGS

An example embodiment of the radial foil bearing designed according to the present disclosure is explained in more detail below with reference to the accompanying drawings. In the figures:

FIG. 1 shows a side view of a radial foil bearing designed according to the present disclosure carrying a shaft;

FIG. 2 shows a perspective view of the radial foil bearing designed according to the present disclosure with a partially broken top foil;

FIG. 3 shows two versions of a corrugated foil of the radial foil bearing according to the present disclosure with symmetrical narrowing;

FIG. 4 shows two versions of a corrugated foil of the radial foil bearing according to the present disclosure with unsymmetrical narrowing;

FIG. 5 shows two versions of a corrugated foil of the radial foil bearing according to the present disclosure with shortened narrowing;

FIG. 6 shows an embodiment of a corrugated foil of the radial foil bearing according to the present disclosure with narrowing that is unsymmetrical in the circumferential direction.

### DETAILED DESCRIPTION

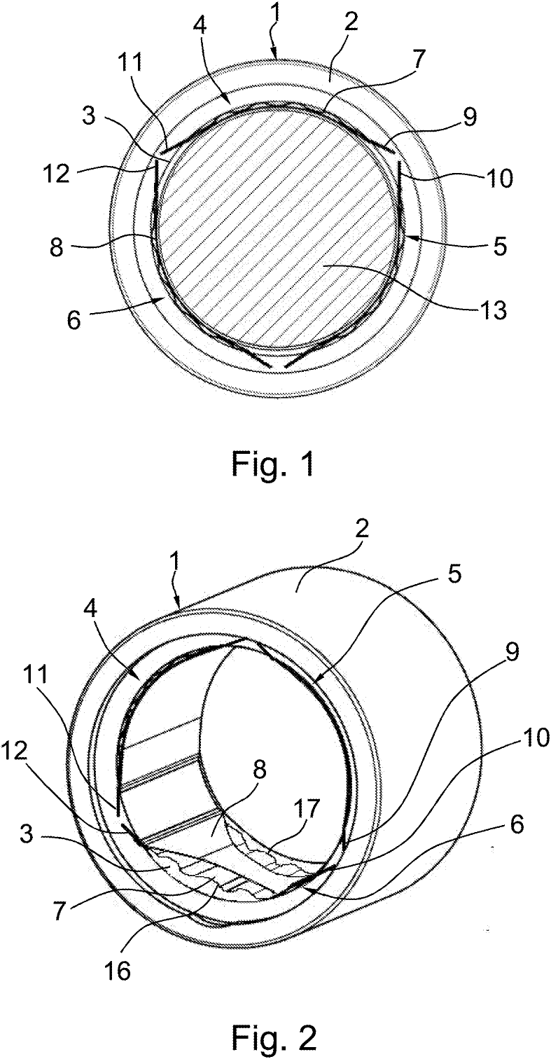

FIG. 1 shows a radial foil bearing 1 for supporting a shaft 13. The radial foil bearing has a sleeve-like bearing housing 2 with at least three foil packs 4, 5, 6 distributed over the inner circumference 3 of the bearing housing 2, each of which covers a portion of the inner circumference 3 of the bearing housing 2. As can be seen in FIG. 2, these foil packs 4, 5, 6 each include an elastic corrugated foil 7 resting against the inner circumference 3 of the bearing housing 2 and a top foil 8, of which the underside rests on the corrugated foil 7 and the top side forms a bearing surface for the shaft 13. Arranged on the inner circumference 3 of the bearing housing 2 are six insertion grooves 9, 10, which extend parallel to the axis of rotation of the bearing and protrude obliquely from the inside outwards into the bearing housing 2. The insertion grooves serve to accommodate the end edges 11, 12 which delimit the corrugated foils 7 and the top foils 8, each in the circumferential direction. The end edges are arranged tangentially in the insertion grooves 9, 10 so as to be freely movable.

Furthermore, it can be seen from FIG. 2 that the corrugated foils 7 have at least one narrowed portion 16, 17 locally at their side edges 14, 15 (ref. FIGS. 3-6) running in the circumferential direction, reducing their axial width B, with which the radial spring rigidity of the corrugated foils 7 can be reduced in the region of their side edges 14, 15. This is intended to ensure that the air pressure caused by the rotation of the shaft 13 is also sufficient at the two side edges of the top foils 8, which are connected to the ambient air pressure, to compress the associated corrugated foils 7 in such a way that the required small distance is created between the top foils 8 and the shaft 13 and there is no longer edge running at these points, which was previously the cause of bearing damage or bearing failures.

In the first embodiment of a corrugated foil 7 shown in FIG. 3, narrowed portions 16, 17 are arranged at both side edges 14, 15 of the corrugated foils 7 and both narrowed portions 16, 17 are designed in the shape of a segment of a circle and symmetrically to one another, in that they have the same depths TT1, TT2 and the same lengths TL1, TL2. The only difference between the two corrugated foils 7 shown and intended for different radial foil bearings is that the depths TT1, TT2 of the narrowed portions in the corrugated foil 7 shown on the left are greater than in the corrugated foil 7 shown on the right.

The alternative second embodiment of a corrugated foil 7 shown in FIG. 4 differs from the embodiment shown in FIG. 3 in that the narrowed portions 16, 17 at both side edges 14, 15 of the corrugated foils 7 are also designed in the shape of a segment of a circle but are unsymmetrical to one another. The narrowed portions 16, 17 can be clearly seen to have different depths TT1, TT2 with the same lengths TL1, TL2, the depths TT1, TT2 of the corrugated foil 7 shown on the left also being greater here than in the corrugated foil 7 shown on the right.

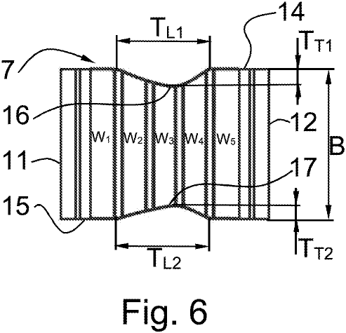

In addition, a third alternative embodiment of a corrugated foil 7 can be seen in FIG. 6. This embodiment includes narrowed portions 16, 17 at both side edges 14, 15 of the corrugated foils 7 that are unsymmetrical in the circumferential direction and have the same depths TT1, TT2 and the same lengths TL1, TL2. In this embodiment, the narrowed portions 16, 17 clearly deviate from the shape of a segment of a circle and instead have a curved or arcuate contour.

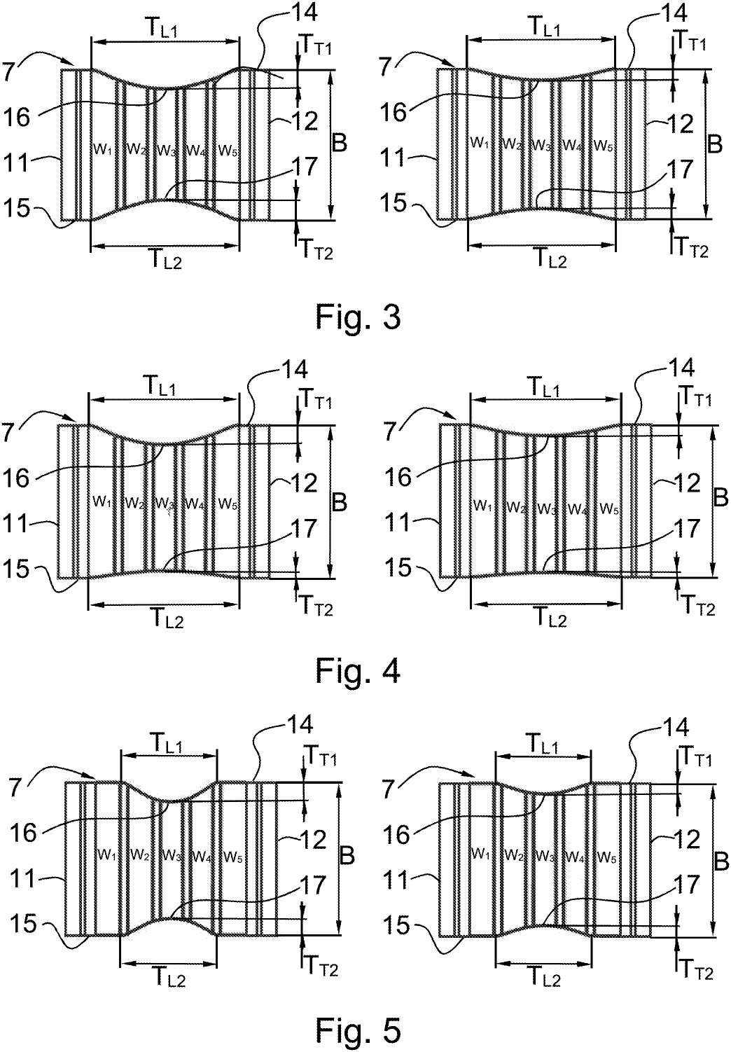

It can also be seen from the drawings that the narrowed portions 16, 17 at both side edges 14, 15 of the corrugated foils 7 extend in the circumferential direction either, as shown in FIGS. 3 and 4, from the first corrugation crest W1 to the last corrugation crest W5 of each corrugated foil 7, or as shown in FIGS. 5 and 6, only from the second corrugation crest W2 to the penultimate corrugation crest W4 of each corrugated foil 7. The selection of these lengths TL1, TL2 of the narrowed portions is dependent on the desired degree of reduction of axial spring rigidity of the corrugated foils 7. In addition, the depths TT1, TT2 of the narrowed portions should be dimensioned in such a way that the width of the corrugated foil 7 between the deepest points of both narrowed portions 16, 17 is between 75% and 95% of the axial width B of the corrugated foils 7 at their end edges 11, 12.

REFERENCE NUMERALS

| | |
|---|---|
| 1 | Radial foil bearing |
| 2 | Bearing housing |
| 3 | Inner circumference of 2 |
| 4 | Foil pack |
| 5 | Foil pack |
| 6 | Foil pack |
| 7 | Corrugated foil |
| 8 | Top foil |
| 9 | Insertion groove |
| 10 | Insertion groove |
| 11 | End edges of 7 |
| 12 | End edges of 8 |
| 13 | Shaft |
| 14 | Side edge of 7 |
| 15 | Side edge of 7 |
| 16 | Narrowed portion at 14 |
| 17 | Narrowed portion at 15 |
| B | Axial width of 7 |
| TT1 | Depth of narrowed portion at 14 |
| TT2 | Depth of narrowed portion at 15 |
| TL1 | Length of narrowed portion at 14 |
| TL2 | Length of narrowed portion at 15 |
| W1 | First corrugation crest of 7 |
| W2 | Second corrugation crest of 7 |
| W4 | Penultimate corrugation crest of 7 |
| W5 | Last corrugation crest of 7 |

1. A radial foil bearing for supporting a shaft, comprising a sleeve-like bearing housing having at least three foil packs distributed over the inner circumference of the bearing housing, each covering a portion of the inner circumference of the bearing housing, each consisting of an elastic corrugated foil resting against the inner circumference of the bearing housing and a top foil, of which the underside rests on the corrugated foil and the top side forms a bearing surface for the shaft, wherein the corrugated foils have at least one narrowed portion locally at their side edges running in the circumferential direction, which reduces their axial width, with which the radial spring rigidity of the corrugated foils can be reduced in the region of their side edges.

2. The radial foil bearing according to claim 1, wherein narrowed portions are arranged at both side edges of the corrugated foils and both narrowed portions are designed in the form of circular sections and symmetrical to one another with the same depths and the same lengths.

3. The radial foil bearing according to claim 1, wherein narrowed portions are arranged at both side edges of the corrugated foils and both narrowed portions are designed in the form of circular sections and unsymmetrical to one another with different depths and equal or unequal lengths.

4. The radial foil bearing according to claim 1, wherein narrowed portions are arranged at both side edges of the corrugated foils and both narrowed portions are designed to be unsymmetrical in the circumferential direction with the same depths and the same lengths.

5. The radial foil bearing of claim 1, wherein the narrowed portions at both side edges of the corrugated foils extend in the circumferential direction from the first corrugation crest to the last corrugation crest of each corrugated foil.

6. The radial foil bearing of claim 1, wherein the narrowed portions at both side edges of the corrugated foils extend in the circumferential direction only from the second corrugation crest to the penultimate corrugation crest of each corrugated foil.

7. The radial foil bearing of claim 1, wherein the depth of the narrowed portion is dimensioned such that the width of the corrugated foil between the lowest points of both narrowed portions is between 75% and 95% of the axial width of the corrugated foils at their end edges.

8. A radial foil bearing for supporting a shaft, comprising:
a sleeve-like bearing housing comprising an inner circumference; and
at least three foil packs distributed over the inner circumference and covering a portion of the inner circumference, each of the at least three foil packs comprising:
an elastic corrugated foil resting against the inner circumference, the elastic corrugated foil comprising:
axially opposite side edges running in a circumferential direction; and
a narrowed portion disposed on at least one of the axially opposite side edges to reduce an axial width and a radial spring rigidity of the elastic corrugated foil at the narrowed portion; and
a top foil comprising:
an underside resting on the elastic corrugated foil; and
a top side forming a bearing surface for the shaft.

9. The radial foil bearing of claim 8 wherein:
each elastic corrugated foil comprises a narrowed portion disposed on each axially opposite side edge; and
the narrowed portions are symmetric circular sections having a same depth and a same length.

10. The radial foil bearing of claim 8 wherein:
each elastic corrugated foil comprises a narrowed portion disposed on each axially opposite side edge; and
the narrowed portions are unsymmetric circular sections having different depths.

11. The radial foil bearing of claim 8 wherein:
each elastic corrugated foil comprises a narrowed portion disposed on each axially opposite side edge; and
the narrowed portions are unsymmetrical in the circumferential direction with same depths and same lengths.

12. The radial foil bearing of claim 8 wherein:
each elastic corrugated foil comprises a narrowed portion disposed on each axially opposite side edge;
each elastic corrugated foil comprises a plurality of corrugation crests; and
the narrowed portions extend circumferentially from a first corrugation crest of the plurality of corrugation crests to a last corrugation crest of the plurality of corrugation crests.

13. The radial foil bearing of claim 8 wherein:
each elastic corrugated foil comprises a narrowed portion disposed on each axially opposite side edge;
each elastic corrugated foil comprises a plurality of corrugation crests; and
the narrowed portions extend circumferentially from a second corrugation crest of the plurality of corrugation crests to a penultimate corrugation crest of plurality of corrugation crests.

14. The radial foil bearing of claim 8 wherein:
each elastic corrugated foil comprises a narrowed portion disposed on each axially opposite side edge; and
the narrowed portions comprise respective depths dimensioned such that an axial width of each of the elastic corrugated foils between lowest points of the narrowed portions is between 75% and 95% of an axial width at an end of the axially opposite side edges.
